(19) United States
(12) Patent Application Publication
(10) Pub. No.: US 2003/0136057 A1
(43) Pub. Date: Jul. 24, 2003

(54) Polishing material for silicon nitride and sialon ceramics

(75) Inventors: Kiyoshi Hirao, Aichi (JP); Shuji Sakaguchi, Aichi (JP); Yukihiko Yamauchi, Aichi (JP); Shuzo Kanzaki, Aichi (JP); Takeshi Sato, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: National Inst. of Advanced Ind. Science and Tech., Tokyo (JP)

(21) Appl. No.: 10/292,491

(22) Filed: Nov. 13, 2002

(30) Foreign Application Priority Data
Nov. 14, 2001 (JP) 2001-348455

(51) Int. Cl. C09K 3/14; C09G 1/02; C09G 1/04

(52) U.S. Cl. 51/307; 51/308; 51/309; 106/3

(57) ABSTRACT

The present invention provides a novel polishing material with which silicon nitride ceramic and sialon ceramic can be polished at high efficiency through a tribochemical reaction, and a method for manufacturing thereof, said material is used for polishing a silicon nitride ceramic or sialon ceramic as a material being polished, through a tribochemical reaction, and consists of a ceramic sinter containing an element that causes the ceramic being polished to undergo a dissolution reaction at the grain boundary of the sinter, within the particles thereof, and/or in pores thereof.

### BACKGROUND OF THE INVENTION

1. Field of the Invention

The present invention relates to a polishing material for silicon nitride ceramics and sialon ceramics, and more particularly relates to a novel polishing material with which a silicon nitride ceramics and sialon ceramics, that is a material being polished, can be polished at high efficiency through a tribochemical reaction, and to a method for manufacturing this material.

2. Description of the Related Art

Surfaces that rub together generally undergo what is known as a tribochemical reaction, in which a chemical reaction is markedly accelerated by the frictional heat of this rubbing, and a known technique for utilizing this reaction to polish ceramics involves rubbing two ceramics together in water to polish one of the rubbing surfaces.

For example, when a silicon nitride ceramic is ground using an abrasive of about #400 grits, wherein two of these surfaces are rubbed together in water, the protruding portions of roughness of the surface of the ceramic to be ground dissolve as a result of a tribochemical reaction (the silicon nitride ceramic reacts with the water to form a hydrate), so the protrusion height becomes extremely low, and as a result a smooth surface thereof is obtained.

In particular, in polishing by tribochemical reaction, a polishing method that does not involve the use of conventional abrasive particles (such as diamond, silica and the like)is used, so a smooth surface can be obtained without the abrasive particles leaving any scratches behind, even under a high pressure to the surface. As a result, this polishing method is characterized by that polishing process can be completed in less time than in the conventional method (about one-fifth to one-tenth compared with the conventional one).

Publications that discuss such prior art include S. R. Hah and T. E. Fischer, “Tribochemical Polishing of Silicon Nitride,” J. Electrochem. Soc., 145, 5 (1998) 1708, and H. Tomizawa and T. E. Fischer, “Friction and Wear of Silicon Nitride and Silicon Carbide in Water,” ASLE Trans., 30, 1 (1987) 41, among others.

The problem with this type of polishing method, though, is that the silicon nitride ceramic that is the polishing material also wears down at the same time. Accordingly, how to increase polishing efficiency (amount of polishing of the material being polished versus the amount of wear in the polishing material) has been a problem in this field of technology, and there has been a great need in this field for the development of a novel technique for solving this problem.

Given this situation, and in light of the above-mentioned prior art, the inventors conducted diligent research aimed at developing a new method for increasing polishing efficiency (amount of polishing of the material being polished versus the amount of wear in the polishing material), and as a result arrived at the present invention upon discovering that with a polishing material consisting of a ceramic sinter, this goal can be achieved by using a ceramic sinter containing an element that causes the ceramic being polished to undergo a dissolution reaction at the grain boundary of this sinter, within the particles thereof, and/or in pores thereof, as the polishing material.

### SUMMARY OF THE INVENTION

Specifically, it is an object of the present invention to provide a novel ceramic polishing material with which silicon nitride ceramics and sialon ceramics can be polished at high efficiency through a tribochemical reaction.

It is another object of the present invention to provide a method for manufacturing the above-mentioned novel polishing material.

The present invention for solving the above problems is constituted by the following technological means.

(1) A polishing material for polishing a silicon nitride ceramic or sialon ceramic as a material being polished through a tribochemical reaction, comprising a ceramic sinter which contains an element that causes the ceramic being polished to undergo a dissolution reaction, at the grain boundary of the sinter, within the particles thereof, and/or in pores thereof.

(2) The polishing material according to (1) above, wherein the matrix phase of the ceramic sinter consists of at least one type of ceramic selected from among alpha-silicon nitride, beta-silicon nitride, alpha-sialon, and beta-sialon.

(3) The polishing material according to (1) above, wherein the element that causes the ceramic being polished to undergo a dissolution reaction is one or more elements selected from among cerium, iron, chromium, titanium, manganese, and zirconium.

(4) The polishing material according to (1) above, wherein the element that causes the ceramic being polished to undergo a dissolution reaction is contained in an amount of less than 50 vol % of the ceramic sinter, when calculated on the basis of the amount of oxide.

(5) The polishing material according to (1) above, wherein the porosity of the ceramic sinter is less than 50 vol %.

(6) The polishing material according to (1) above, wherein the average pore diameter of the ceramic sinter is 100 μm or less.

(7) A method for manufacturing the polishing material defined in (1) above, comprising adding a powder of an oxide of the element that causes the ceramic being polished to undergo a dissolution reaction to a silicon nitride ceramic or sialon ceramic powder, mixing the components, molding the mixture, and then sintering this molded product at a temperature from 1500° C. to 1900° C. to produce a ceramic sinter containing the element that causes the ceramic being polished to undergo a dissolution reaction at the grain boundary of the sinter, within the particles thereof, and/or in pores thereof.

(8) The method for manufacturing a polishing material according to (7) above, wherein the oxide is at least one type selected from among cerium oxide, iron oxide, chromium oxide, titanium oxide, manganese oxide, and zirconium oxide.

(9) The method for manufacturing a polishing material according to (7) above, wherein the oxide powder is added to the ceramic powder in an amount of less than 50 vol %.

### DESCRIPTION OF THE PREFERRED EMBODIMENTS

The present invention will now be described in further detail.

When a silicon nitride ceramic or sialon ceramic is to be polished, if the polishing thereof is accomplished through a tribochemical reaction in water, the surface of the silicon nitride ceramic or sialon ceramic reacts with the water to generate the surface constantly covered by silicon based oxide during the polishing. Accordingly, this oxide must be efficiently removed if the material being polished is to be polished efficiently.

The inventors focused on a method for polishing silicate based glass as a way to remove silicon based oxides efficiently, and used the information thus obtained to conduct various studies aimed at developing a new method. A slurry comprising water added to particles of zirconium oxide, cerium oxide, chromium oxide, iron oxide, or other such oxide powder is generally used to polish silicate based glass. Polishing mechanism by the slurry of cerium oxide powder, for instance, is as follows. During polishing, the Si—OH bonds on the surface of the silicate based glass react with the M—OH (M is elemental cerium) on the surface of the cerium oxide particle to form Si—O—M bonds. Since the cerium oxide particles here are moving relative to the silicate based glass, the Si—O bonds in the Si—O—M bonds are broken as the silicate glass is polished. In particular, there are a very large number of M—OH bonds on the surface of the above-mentioned oxide powder particles, and in the Si—O—M bonds, the O—M bonding strength is higher than the Si—O bonding strength, so the Si—O bonds break, allowing polishing to proceed efficiently.

In view of this, the inventors succeeded at developing the polishing material of the present invention as a result of various studies into raising the efficiency of polishing in which the above-mentioned oxides are used in the polishing of silicon nitride ceramics or sialon ceramics as materials to be polished through a tribochemical reaction. The present invention is characterized in that one of the above-mentioned oxides is added to a ceramic sinter such as a silicon nitride ceramic as the polishing material. One way to add the above-mentioned oxide to the polishing material is to utilize the oxide as a sintering auxiliary during the production of a ceramic sinter of a silicon nitride ceramic or the like as the polishing material.

We will now describe the method for producing a ceramic sinter containing an element that causes the ceramic being polished to undergo a dissolution reaction in the present invention. As the starting raw material of the polishing material, a powder of alpha-silicon nitride, beta-silicon nitride, alpha-sialon, or beta-sialon is used, and the element that causes the ceramic being polished to undergo a dissolution reaction is added as an oxide to this starting raw material, and then this product is sintered at a high temperature between 1500-1900° C., causing the above-mentioned element to be contained at the grain boundary of this sinter, within the particles thereof, and/or in pores thereof. Alternatively, a porous ceramic can be produced ahead of time using a powder of alpha-silicon nitride, beta-silicon nitride, or the like as the starting raw material, after which the pores in this porous ceramic are impregnated with the above-mentioned oxide, and this product is then sintered.

The oxide in the present invention can be one or more types selected from among cerium oxide, iron oxide, chromium oxide, titanium oxide, manganese oxide, and zirconium oxide.

Preferably, a powder of one or more of these oxides is added in an amount of less than about 50 vol % to a silicon nitride ceramic or sialon ceramic powder, this mixture is sintered at a temperature from 1500° C. to 1900° C., and this sinter is used as an polishing material. In this case, the sintering can be accomplished by gas pressure sintering, hot pressing, electric heating sintering, hot isostatic pressing sintering, or another such process.

The amount in which the oxide is added is preferably less than 50 vol %, the reason being that the strength of the matrix phase itself will decrease if the oxide content is 50 vol % or higher, and as a result, the very hard silicon nitride ceramic or sialon ceramic particles that make up the matrix phase will fall out during polishing, and these fallen particles scratch the polishing surface.

Meanwhile, a sinter with a 100% oxide content is conceivable, and while such a sinter will not scratch the polishing surface, there will too much wear of the polishing material itself, so the polishing efficiency (amount of abrasive of the material being polished versus the amount of wear in the polishing material) will be low.

The method for having the above-mentioned oxide be contained at the grain boundary of this sinter, within the particles thereof, and/or in pores thereof is not limited to the above method, and any suitable method can be employed. In the present invention, it is possible, as discussed above, to use a method such as one in which a porous silicon nitride ceramic sinter is impregnated with the above-mentioned oxide. The phrase “having the above-mentioned oxide be contained at the grain boundary of this sinter, within the particles thereof, and/or in pores thereof” as used in the present invention means that this oxide is present as a crystal phase or glass phase at the grain boundary or in pores, or the elemental metal of the oxide is present as a solid solution inside the particles.

It is possible to leave pores in the polishing material in order for the polished material that has been dissolved during polishing to be efficiently removed to away from the polishing surface, and an example of how this can be accomplished is to adjust the proportions to 70 vol % matrix phase, 10 vol % oxide, and 20 vol % pores. The pore diameter is preferably 100 μm or less, and the porosity less than 50 vol %. The reason for this is that the strength of the matrix phase will decrease outside the above range, and particles that fall out of the matrix phase will scratch the polishing surface.

Also, as mentioned above, a silicon nitride ceramic or sialon ceramic sinter of the same matrix phase composition as the material being polished can be used favorably as ceramic material used for the polishing material in the present invention because no reaction product with the material being polished will be on the polishing surface, but anything that has the same effect can be similarly used.

The present invention is characterized in that the above-mentioned oxide is contained in a silicon nitride ceramic or sialon ceramic sinter as the polishing material, and the use of this polishing material allows the silicon nitride ceramic or sialon ceramic as the material being polished to be polished at high polishing efficiency through a tribochemical reaction. If the polishing is performed in water, the polishing surface of the silicon nitride ceramic (Si—N) that serves as the material being polished, for example, will be constantly rubbed by the polishing material during polishing, so oxidation (Si—O) and hydration (Si—OH) reactions occur on this surface. If the polishing material of the present invention is used here, since an element (M) that dissolves the ceramic being polished is contained, this element (M) reacts with the Si—OH bonds to form Si—O—M bonds. The ceramic being polished is moving relative to the polishing material, and it is believed that the Si—O bonds in the Si—O—M bonds are therefore broken, allowing the polishing to proceed more efficiently. If the element (M) that dissolves the ceramic being polished were not contained in the polishing material, no reaction that produces these Si—O—M bonds would occur, so the polishing efficiency would be low.

Under the same polishing conditions (polishing pressure and speed) as in the conventional method, the amount of polishing with the present invention is four times compared with that in the conventional method, and at the same time, the amount of wear in the ceramic sinter (the abrasive material) is only one-sixth compared with that in conventional method, and as a result the polishing efficiency is 24 times higher.

### BRIEF DESCRIPTION OF THE DRAWINGS

FIG. 1 is a diagram illustrating the method for polishing a silicon nitride ceramic sinter in an example of the present invention;

FIG. 2 is a graph illustrating the amount of polishing of a ball polished with various polishing materials;

FIG. 3 is a graph illustrating the amount of wear of various polishing materials in the polishing of a ball; and

FIG. 4 is a graph of the polishing efficiency with various polishing materials.

### DESCRIPTION OF SYMBOLS

1 a loading direction applied to the surface to be polished

2 a ceramic ball holder

3 a ceramic ball to be polished

4 water

5 a ceramic polishing material

6 a ceramic polishing material holder

7 a rotating direction of a holder

### EXAMPLES

The present invention will now be described in specific terms through examples, but is not limited in any way by the following examples.

### Example

### (1) Production of Silicon Nitride Ceramic Polishing Material

Cerium oxide and manganese oxide were added in respective amounts of 3.8 vol % and 1.9 vol % to an alpha-silicon nitride raw material powder. These components were mixed for 30 minutes in a planetary mill using methanol as a dispersion medium and using a silicon nitride ball and pot. Next, the methanol of the mixture was removed with a vacuum evaporator, after which the remainder was dried at 100° C. and granulated into a powder using a 125 mesh sieve. This powder was packed into carbon mold with a diameter of 30 mm, then electrically heated and sintered at 1700° C. The sintering conditions comprised pressing at a pressure of 30 MPa in a nitrogen atmosphere (0.1 MPa). The sinter thus obtained was lapped with diamond having a particle size of 0.25 μm, which completed a polishing material having a diameter of 30 mm and a thickness of 5 mm. A commercially available silicon nitride ceramic sinter was used as a comparative material.

### (2) Polishing of Silicon Nitride Ceramic

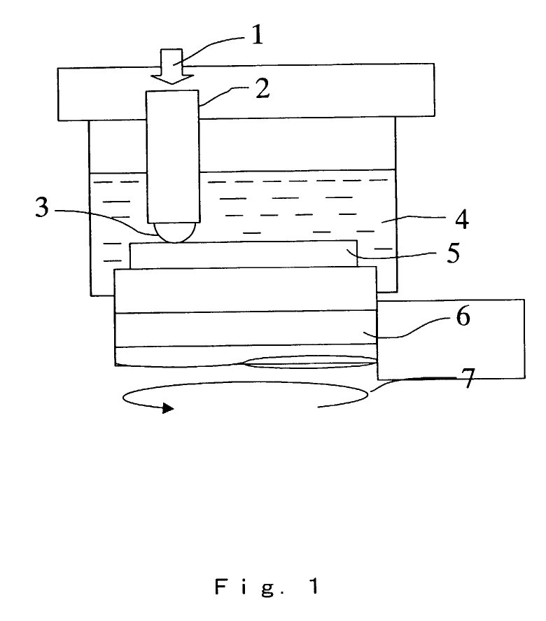

A silicon nitride ceramic was polished by tribochemical reaction for 1 hour, in distilled water, at a load of 15 N and a peripheral speed of 0.18 m/sec, by using the ball-on-disk type of friction and wear testing method shown in FIG. 1.

Specifically, a ceramic ball to be polished 3 was held by a ceramic ball holder 2, and a load was applied in the loading direction 1 to the surface to be polished. Meanwhile, a ceramic polishing material 5 was placed in a ceramic polishing material holder 6, and then this holder was rotated in the predetermined rotating direction of the holder 7 to polish the ceramic ball in distilled water 4. The temperature of the distilled water was 15° C., and the water flowed continuously at a flux of 30 mL/min. The material to be polished was made into a silicon nitride ceramic ball polished to a diameter of 10 mm.

### (3) Evaluation of Wear Characteristics of Polishing Surface

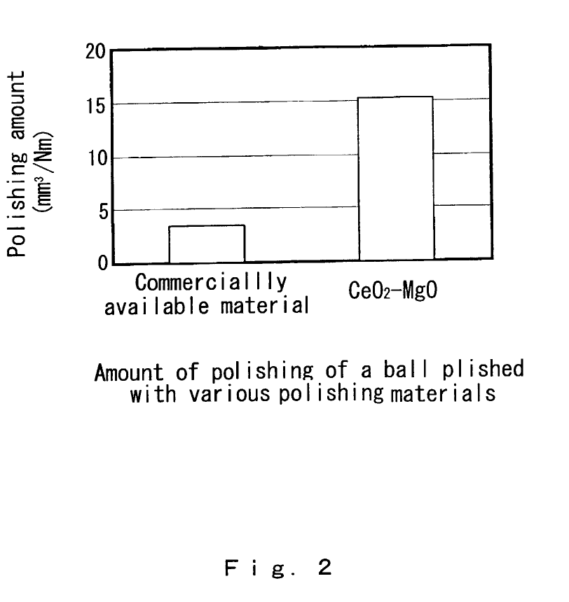

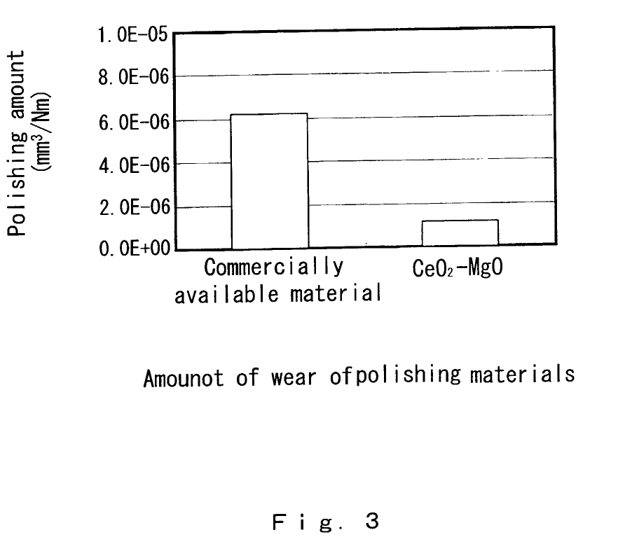

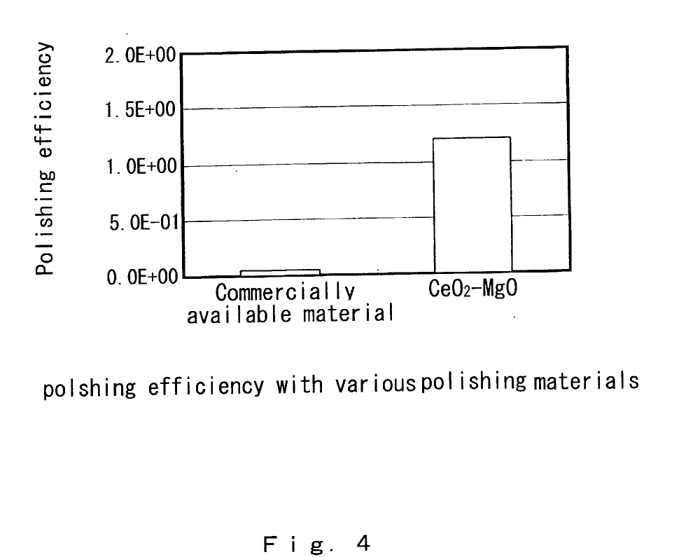

To evaluate the amount of polishing, the amount of wear polished from the ball surface against the volume thereof was termed the polishing amount. The amount of wear of the polishing material against the volume thereof during polishing was termed the wear amount. These results are given in FIGS. 2 to 4. As shown in FIG. 2, the polishing amount with the ceramic polishing material of the present invention was four times compared with that of the commercially available ceramic. Also, as shown in FIG. 3, the amount of wear of the polishing material itself was reduced greatly, to just one-sixth compared with that of the conventional material. As a result, as shown in FIG. 4, the polishing efficiency (polishing amount/wear amount) was 24 times that of the conventional material, meaning that the process was far more efficient.

As detailed above, the present invention pertains to silicon nitride ceramic and sialon ceramic polishing materials, and the effects of the present invention are that 1) it provides a novel polishing material with which the polishing of silicon nitride and sialon ceramics to be polished can be performed through a tribochemical reaction at high polishing efficiency, 2) under the same polishing conditions as in the conventional materials, the polishing amount is four times as large, the wear amount of the ceramic sinter as polishing material is only one-sixth, and the polishing efficiency is 24 times as high, 3) time for polishing can be reduced, 4) a smooth polishing surface is obtained, and 5) the cost of polishing is can be reduced because abrasive particles (such as diamond and the like) are not used.

What is claimed is:

1. A polishing material for polishing a silicon nitride ceramic or sialon ceramic as a material being polished through a tribochemical reaction, comprising a ceramic sinter which contains an element that causes the ceramic being polished to undergo a dissolution reaction, at the grain boundary of the sinter, within the particles thereof, and/or in pores thereof.

2. The polishing material according to claim 1, wherein the matrix phase of the ceramic sinter consists of at least one type of ceramic selected from among alpha-silicon nitride, beta-silicon nitride, alpha-sialon, and beta-sialon.

3. The polishing material according to claim 1, wherein the element that causes the ceramic being polished to undergo a dissolution reaction is one or more elements selected from among cerium, iron, chromium, titanium, manganese, and zirconium.

4. The polishing material according to claim 1, wherein the element that causes the ceramic being polished to undergo a dissolution reaction is contained in an amount of less than 50 vol % of the ceramic sinter, when calculated on the basis of the amount of oxide.

5. The polishing material according to claim 1, wherein the porosity of the ceramic sinter is less than 50 vol %.

6. The polishing material according to claim 1, wherein the average pore diameter of the ceramic sinter is 100 μm or less.

7. A method for manufacturing the polishing material defined in claim 1, comprising adding a powder of an oxide of the element that causes the ceramic being polished to undergo a dissolution reaction to a silicon nitride ceramic or sialon ceramic powder, mixing the components, molding the mixture, and then sintering this molded product at a temperature from 1500° C. to 1900° C. to produce a ceramic sinter containing the element that causes the ceramic being polished to undergo a dissolution reaction at the grain boundary of the sinter, within the particles thereof, and/or in pores thereof.

8. The method for manufacturing a polishing material according to claim 7, wherein the oxide is at least one type selected from among cerium oxide, iron oxide, chromium oxide, titanium oxide, manganese oxide, and zirconium oxide.

9. The method for manufacturing a polishing material according to claim 7, wherein the oxide powder is added to the ceramic powder in an amount of less than 50 vol %.
